(19) United States
(12) Patent Application Publication
(10) Pub. No.: US 2025/0154431 A1
(43) Pub. Date: May 15, 2025

(54) SUNFLOWER OLEOSOME FRACTION AND PROCESS FOR PREPARING IT

(71) Applicant: CARGILL, INCORPORATED, Wayzata, MN (US)

(72) Inventors: Lucía CABAS-RODRIGUEZ, Almeria (ES); Eliane Yvonne GOOSENS, NIEL (BE); Gustav Maximilian WASCHATKO, Etterbeek (BE)

(21) Appl. No.: 18/834,675

(22) PCT Filed: Jan. 26, 2023
(86) PCT No.: PCT/US2023/061350

§ 371 Date: Jul. 31, 2024

(30) Foreign Application Priority Data
Feb. 3, 2022 (EP) 22155053.6

(51) Int. Cl. C11B 3/00; A23D 9/007; A23D 9/04; A23K 10/30; A23K 20/158; C11B 1/04; C11B 3/04

(52) U.S. Cl. CPC C11B 3/001; A23D 9/007; A23D 9/04; A23K 10/30; A23K 20/158; C11B 1/04; C11B 3/04

(57) ABSTRACT

A process for isolating a sunflower oleosome fraction; comprising a) Grinding sunflower seeds in aqueous solution and obtaining a sunflower seed slurry with pH of more than 7.2, wherein a reducing agent and/or an acidulant is added during grinding and/or wherein it is added to the slurry; and b) isolating a sunflower oleosome fraction. Invention describes a sunflower oleosome fraction or a concentrate comprising isolated and/or washed oleosomes and a reducing agent and/or an acidulant in an amount of from 0.10 to 1.50 wt %. It describes the use of a reducing agent and/or an acidulant for prevention of green coloring.

### CROSS-REFERENCE TO RELATED APPLICATION

This application claims the benefit of European Application No. 22155053.6, filed Feb. 3, 2022, which is incorporated by reference herein in its entirety.

### FIELD OF THE INVENTION

The invention relates to a process for isolating a sunflower oleosome fraction from sunflower seeds. The invention further relates to a sunflower oleosome fraction, a sunflower oleosome concentrate and food and feed products, pharmaceutical products, personal care products, nutritional compositions and industrial products comprising said sunflower oleosome fraction or concentrate.

### BACKGROUND OF THE INVENTION

Oleosomes, also known as “oil bodies”, “lipid bodies”, “lipid droplets” or “spherosomes”, are pre-emulsified droplets or vesicles of oil stored in plant seeds and used as energy source for plant growth and metabolism.

Oleosomes are typically extracted from cells by a process of grinding the seeds, followed by solid-liquid separation to obtain an aqueous suspension of oleosomes. Said suspension is centrifuged to separate the oleosomes from the remaining seed content and obtain an oleosome fraction.

It is important that the process conditions for isolating oleosome fractions are such that the yield of oleosome fractions obtained from the oil seeds is maximised. Unfortunately, while maximizing yield, the oleosome fractions obtained according to existing processes are of an inferior sensorial quality, in terms of taste and/or colour. This is especially the case when isolating oleosome fractions from sunflower seeds.

Therefore, there is a need in industry to identify an efficient and effective method for obtaining sunflower oleosome fractions with good sensorial characteristics.

### SUMMARY OF THE INVENTION

The current invention relates to a process for isolating a sunflower oleosome fraction, and the process comprises the steps, in order, of:
a) Grinding sunflower seeds in the presence of an aqueous solution and obtaining a sunflower seed slurry having a pH of more than 7.2, wherein a reducing agent and/or an acidulant is added during the grinding and/or wherein a reducing agent and/or an acidulant is added to the obtained sunflower seed slurry; and
b) Isolating from the sunflower seed slurry a sunflower oleosome fraction, wherein the reducing agent and/or an acidulant is selected from the group consisting of ascorbic acid, erythorbic acid, allyl isothiocyanate, cysteine, glutathione, dithiothreitol, sodium bisulfite, citric acid, malic acid, carnosic acid, any derivative thereof and any combination of two or more thereof.

The invention further relates to a sunflower oleosome fraction or a sunflower oleosome concentrate comprising isolated and/or washed isolated oleosomes and an amount of reducing agent and/or acidulant in a range of from 0.10 to 1.50 wt. % on total dry weight of sunflower oleosome fraction or concentrate, wherein the reducing agent and/or an acidulant is selected from the group consisting of ascorbic acid, erythorbic acid, allyl isothiocyanate, cysteine, glutathione, dithiothreitol, sodium bisulfite, citric acid, malic acid, carnosic acid, any derivative thereof and any combination of two or more thereof.

Furthermore, the invention relates to a process for preparing food and feed products, pharmaceutical products, personal care products, nutritional compositions and industrial products, and the process is comprising the step of blending the sunflower oleosome fraction or sunflower oleosome concentrate according to the present invention with at least one ingredient other than oleosomes.

Finally, the current invention relates to the use of a reducing agent and/or an acidulant for prevention of green coloring of a sunflower oleosome fraction or a sunflower oleosome concentrate, wherein the reducing agent and/or an acidulant is selected from the group consisting of ascorbic acid, erythorbic acid, allyl isothiocyanate, cysteine, glutathione, dithiothreitol, sodium bisulfite, citric acid, malic acid, carnosic acid, any derivative thereof, and any combination of two or more thereof.

### DETAILED DESCRIPTION

The current invention relates to a process for isolating a sunflower oleosome fraction and the process is comprising the steps, in order, of:
a) Grinding sunflower seeds in the presence of an aqueous solution and obtaining a sunflower seed slurry having a pH of more than 7.2, wherein a reducing agent and/or an acidulant is added during the grinding and/or wherein a reducing agent and/or an acidulant is added to the obtained sunflower seed slurry; and
b) Isolating from the sunflower seed slurry a sunflower oleosome fraction,
wherein the reducing agent and/or an acidulant is selected from the group consisting of ascorbic acid, erythorbic acid, allyl isothiocyanate, cysteine, glutathione, dithiothreitol, sodium bisulfite, citric acid, malic acid, carnosic acid, any derivative thereof and any combination of two or more thereof.

For the process of the current invention any type of sunflower seeds, belonging to the species Helianthus annuus, may be used.

Several types of sunflower seeds exist, each characterized by the fatty acid profile of the oil present in these seeds. Sunflower seeds contain sunflower oil that is characterized by a typical profile of 66 to 72% linoleic acid, 9 to 13% saturated fatty acids (palmitic and stearic), 17 to 23% oleic acid, and less than 1% alpha-linolenic acid.

Other well-known varieties of sunflower seeds are mid- and high oleic sunflower seeds. Typically, a high-oleic sunflower oil is characterized by a content of 7 to 11% linoleic acid, 7 to 11% saturated fatty acids (palmitic and stearic), 80 to 86% oleic acid, and less than 1% alpha-linolenic acid. Typically, a mid-oleic sunflower oil is characterized by a content of 24 to 28% linoleic acid, 7 to 11% saturated fatty acids (palmitic and stearic), 62 to 68% oleic acid, and less than 1% alpha-linolenic acid.

Preferably the sunflower seeds used in the process according to the present invention are mid- or high-oleic sunflower seeds; more preferably high-oleic sunflower seeds.

The process steps a) and b), and optionally process steps of soaking and washing, of the process according to the invention are performed at a temperature that does not exceed 60° C., preferably 55° C., more preferably 50° C.

Furthermore, the process steps a) to b), and optionally process steps of soaking and washing, of the process according to the invention are performed in absence of an organic solvent. The organic solvent may be acetone, hexane, ethanol and the like.

Step a) Obtaining a Sunflower Seed Slurry Having pH of More than 7.2

A sunflower seed slurry is obtained in step a) of the process according to the invention. The sunflower seed slurry is a slurry comprising oleosomes, fibers and proteins. “Oleosomes”, also known as “oil bodies”, “lipid bodies”, “lipid droplets” or “spherosomes” are pre-emulsified droplets or vesicles that are by nature present in cells or plant seeds for storage of oil. They are used as energy source for plant growth and metabolism.

Typically, sunflower seeds are cleaned and/or dehulled prior to grinding.

The sunflower seeds are grinded using a mill such as, but not limited to, a ball-mill, a toothed colloid mill, a stone mill, or a rotor-stator mill. For grinding, an aqueous solution is added to the sunflower seeds in a ratio water to dry seeds of from 15/1 to 3/1, from 12/1 to 4/1 or from 10/1 to 5/1 prior to the grinding. Preferably, grinding is occurring at a temperature in a range of from 4 to 20° C., from 4 to 10° C., or from 4 to 8° C.

In one aspect of the invention, the grinding of the sunflower seeds in step a) is preceded by soaking and/or washing of the sunflower seeds.

The sunflower seeds may be allowed to soak in aqueous solution for a period of from 0.5 to 48 hours, from 0.75 to 24 hours, or from 1.0 to 12 hours. The sunflower seeds may be agitated during the period of soaking.

The sunflower seeds are subsequently grinded together with the aqueous solution. Preferably, soaking is occurring at a temperature in a range of from 4 to 20° C., from 4 to 10° C., or from 4 to 8° C.

Optionally, following the period of soaking and prior to grinding, the aqueous solution may be removed, and the sunflower seeds may be washed one or more times by adding fresh aqueous solution. The sunflower seeds are subsequently grinded together with aqueous solution.

The aqueous solution, that is used in the preparations of the sunflower seed slurry, i.e. for grinding, soaking and/or washing, is water. Optionally, the aqueous solution may be an alkaline aqueous solution with a pH of more than 7.2, of 7.5 or more, or of 7.8 or more. Alkaline aqueous solutions, such as, but not limited to, sodium hydroxide or sodium bicarbonate, may be used.

The sunflower seed slurry obtained from step a) of the process according to the invention has a pH of more than 7.2, preferably of 7.5 or more, more preferably of 7.8 or more prior to step b). The sunflower seed slurry may have pH of not more than 10.0, preferably not more than 9.5, more preferably not more than 9.0. The sunflower seed slurry may have pH in a range of from 7.2 to 9.0, from 7.5 to 8.5, or from 7.8 to 8.0.

The sunflower seed slurry having a pH of more than 7.2 may be obtained by adding a concentrated alkali solution to the sunflower seed slurry. Alternatively, the sunflower seed slurry having a pH of more than 7.2 may be obtained by using an alkaline solution for grinding the sunflower seeds and, optionally, by further adjusting the pH by adding a concentrated alkali solution.

In a preferred aspect, the reducing agent and/or an acidulant that is added in step a) of the process, is selected from the group consisting of cysteine, ascorbic acid, erythorbic acid and any combination of two or more thereof; more preferably the antioxidant is ascorbic acid and/or cysteine.

The addition of the reducing agent and/or the acidulant is occurring not more than 60 minutes, more preferably not more than 45 minutes, most preferably not more than 30 minutes after the sunflower seed slurry is adjusted to a pH of 7.2 or higher. Preferably, the addition of the reducing agent and/or the acidulant is occurring before the sunflower seed slurry is adjusted to a pH of 7.2 or higher.

Alternatively, if soaking and/or grinding is occurring in the presence of an alkali solution of pH 7.2 or higher, addition of the reducing agent and/or the acidulant is occurring not more than 60 minutes, more preferably not more than 45 minutes, most preferably not more than 30 minutes after the aqueous solution for soaking and/or grinding is adjusted to a pH of 7.2 or higher. Preferably, the addition of the reducing agent and/or the acidulant is occurring prior to addition of the alkali solution for soaking and/or grinding.

In one aspect of the invention, the reducing agent and/or the acidulant in step a) is added in an amount of from 0.15 to 1.50 wt. %, from 0.30 to 1.25 wt. %, or from 0.50 to 1.00 wt. % based on total dry weight of sunflower seed slurry.

The process step of grinding in step a) of the process according to the invention results in a sunflower seed slurry having particles with a size in a range of from 5 to 200 micron, from 10 to 190 micron, or from 15 to 180 micron.

The sunflower seeds slurry is characterized in that it has, based on total dry matter:
a protein content of from 12 to 28 wt. %, or from 15 to 25 wt. %, or from 17 to 23 wt. %, and
a lipid content of from 55 to 70 wt. %, or from 58 to 68 wt. %, or from 60 to 65 wt. %, of which at least 70%, at least 80%, or at least 90% is contained in oleosomes,
a fiber content of from 5 to 11 wt. %, or from 6 to 10 wt. %, or from 7 to 9 wt. %, and
a content of reducing agent and/or the acidulant of from 0.15 to 1.50 wt. %, from 0.30 to 1.25 wt. %, or from 0.50 to 1.00 wt. %.

In the current invention, the term “lipid” or “lipids” is encompassing tri-, di-, monoglycerides, fatty acids and phospholipids.

In the present invention, the protein content of a composition, such as a sunflower seeds slurry, sunflower oleosome fraction, or a sunflower oleosome concentrate, is expressed as the total Nitrogen content of the composition multiplied by 6.25; said total Nitrogen content being determined according to the Dumas combustion method.

### Step b) Isolating a Sunflower Oleosome Fraction

In step b) of the process of the invention a sunflower oleosome fraction is isolated from the sunflower seed slurry having a pH of more than 7.2. Preferably, isolation of the sunflower oleosome fraction is occurring at a temperature in a range of from 4 to 20° C., from 4 to 10° C., or from 4 to 8° C.

For isolating the sunflower seed fraction, the sunflower seed slurry comprising the reducing agent and/or the acidulant obtained from step a) may be separated into a solid fraction and a liquid fraction. Separation may be performed by means of filtration, centrifugation, or decantation. The solid fraction obtained is a fraction that is rich in fibers (sunflower cake). The liquid fraction is containing proteins and oleosomes

The obtained liquid fraction is subsequently further separated by applying centrifugal acceleration which separates the filtrate into two liquid phases, a watery phase, i.e. a protein-rich fraction (sunflower milk) and an oily oleosome containing phase (sunflower cream) (i.e. the sunflower oleosome fraction).

Alternatively, for isolating the sunflower seed fraction, in step b) of the process the sunflower seed slurry comprising the reducing agent and/or the acidulant obtained from step a) may be submitted to a liquid-solid-liquid separation (three-phase separation) using a centrifugal tricanter. Such a separation is resulting in three fractions: the sunflower oleosome fraction (cream), a fiber-rich fraction (cake), and a protein-rich fraction (milk).

In one aspect, the process according to the present invention is performed in the absence of organic solvent. The organic solvent may be acetone, hexane, ethanol and the like.

The sunflower oleosome fraction obtained from step b) of the process according to the invention is comprising proteins and lipids and at most 40%, at most 30%, at most 20%, or at most 10% of the lipids is present as free oil

The sunflower oleosome fraction may further comprise small amounts of remaining fibers in an amount of up to 0.5 wt. % and/or minerals, expressed as ash content in an amount of up to 0.7 wt. % on total dry matter.

The process according to the present invention results in a yield of the sunflower oleosome fraction, in a range of from 27 to 55 dry weight %, 30 to 50 dry weight % or 35 to 45 dry weight %. The yield of oleosome fraction is expressed as the dry weight of oleosome fraction obtained from the 100 g dry weight of dehulled sunflower seeds.

The process according to the present invention results in a sunflower oleosome fraction with a creamy-white colour, having colour values according to CIELAB of:
°h in a range of from 85 to 95, from 86 to 94, or from 87 to 93 and C* of from 8.0 to 14.0, from 8.2 to 13.8, or from 8.4 to 13.6; or
°h above 95, above 96, or above 97, and C* below 10.0, below 9.8, or below 9.6;
   measured on sunflower oleosome fraction standardized to a dry substance in a range of 30 to 35% and a pH in a range of 6.9 to 7.1, using an illuminant D65, an observation angle of 10°, specular component excluded and a view diameter of 30 mm.

Each color can be represented by numerous color spaces. These spaces are standardized by the Commision International d′Eclairage (CIE) under a series of standard conditions. CIELAB L*a*b* is a color space that is commonly used for the analysis of colorimeter information, where L* defines lightness or darkness, a* redness or greenness, and b* yellowness or blueness.

Hue (° h) and Chromaticity (C*) can be calculated based on measured L*a*b* values.

Hue angle (° h) refers to the degree of the dominant spectral component, such as red, green, and blue, and ranges from 0° to 360°. An angle of 0° or 360° represents red Hue. Angles of 90°, 180°, and 270° respectively represent yellow, green, and blue Hue.

Color measurements are performed on sunflower oleosome concentrate standardized to a dry substance in a range of 30 to 35% and a pH in a range of 6.9 to 7.1, using an illuminant D65, an observation angle of 10° and an aperture size of 30 mm.

The process of the current invention results in a sunflower oleosome fraction that has a creamy white colour and a good functionality while maintaining a high recovery yield obtained from the sunflower seeds.

When isolating oleosomes from oilseeds, particular caution needs to be taken in the case of sunflower seeds in order to avoid green colouring of the isolated oleosomes

In comparison, existing processes for isolation of sunflower oleosome fractions have solved the greening effect by washing the isolated sunflower oleosomes one or more times. However, this results in a loss of oleosomes during each of the washing steps and thus a loss in recovery yield of oleosomes from the sunflower seeds. Additionally, these washing steps may also result in a loss of certain desired functionalities of the isolated oleosomes, such as foaming capacity, robustness to shear stress and/or emulsification capacity

Other existing processes avoid green colouring of the isolated oleosomes fraction by lowering the pH conditions during isolation to below pH 7. Such processes, however, result in a very low recovery yield.

### Additional Process Features

### Roasting

In one aspect of the invention, the sunflower seeds may be subjected to a roasting process prior to step a) of the process according to the invention. Roasting may be applied by means of hot air at a temperature of from 110 to 145° C. for a period of from 15 to 60 minutes, from 115 to 135° C. for a period of from 20 to 45 minutes, or from 120° C. to 130° C. for a period of from 30 to 50 minutes. While roasting, a relative humidity in a range of from 10 to 30%, from 12 to 25%, or from 15 to 20% may be applied. This level of humidity may be achieved by injection of steam while roasting.

Roasting of the sunflower seeds may result in a pleasant taste and/or flavour of the oleosome fraction obtained in the process according to the invention. The taste of such oleosome fraction from sunflower seeds that has not been subjected to a roasting step may be described as a more vegetable, greenish taste. By subjecting the sunflower seeds to a roasting process, the vegetable, greenish taste may be reduced or even removed from the oleosome fraction from these sunflower seeds. A more neutral taste is obtained that may, depending on the food application wherein the sunflower oleosome fraction is used, be perceived as more pleasant. However, these sunflower oleosome fractions have substantially no or minor typical flavors associated with roasting.

### Step c) Washing the Sunflower Oleosome Fraction and Isolating a Sunflower Oleosome Concentrate

In another aspect, the process of the invention comprises a further process step c) of washing the sunflower oleosome fraction obtained from step b) in an aqueous solution and isolating a sunflower oleosome concentrate. Preferably, washing and isolation of the sunflower oleosome concentrate is occurring at a temperature in a range of from 4 to 20° C., from 4 to 10° C., or from 4 to 8° C.

For washing, the sunflower oleosome fraction is resuspended in an aqueous solution, such as water or a buffer solution like for example a sodium bicarbonate (NaHCO₃) buffer solution. The dry matter content of the resuspended sunflower oleosome fraction may be in a range of from 7 to 15 wt. %, from 8 to 14 wt. % of from 9 to 13 wt. %. Subsequently, the sunflower oleosome concentrate is isolated from the resuspended sunflower oleosome fraction by applying centrifugal acceleration. The centrifugal acceleration results into two liquid phases, a watery phase, i.e. a protein-rich fraction and an oily oleosome containing phase, i.e. the sunflower oleosome concentrate. The washing step may be conducted 1 up to 4 times.

In a preferred aspect, the aqueous solution for washing the sunflower oleosome fraction in step c) has a pH in a range of from 6.6 to 7.0, from 6.6 to 6.9, or from 6.7 to 6.8. The pH of the washed sunflower oleosome fraction may be adjusted using an aqueous acid solution such as a 10% solution of hydrochloric acid, sulphuric acid, lactic acid, citric acid or the like. The washing of the sunflower oleosome concentrate in step c) of the process at a pH in a range of from 6.6 to 7.0, may result in a sunflower oleosome concentrate with a creamy-white colour, having colour values according to CIELAB of:
°h in a range of from 85 to 95, from 86 to 94, or from 87 to 93 and C* of from 8.0 to 14.0, from 8.2 to 13.8, or from 8.4 to 13.6; or,
°h above 95, above 96, or above 97, and C* below 10.0, below 9.8, or below 9.6;
   measured on sunflower oleosome fraction standardized to a dry substance in a range of 30 to 35% and a pH in a range of 6.9 to 7.1, using an illuminant D65, an observation angle of 10°, specular component excluded and a view diameter of 30 mm.

Alternatively, the aqueous solution for washing the sunflower oleosome fraction in step c) has a pH of more than 7.2, whereby the aqueous solution is comprising a reducing agent and/or an acidulant. The reducing agent and/or the acidulant may be present in an amount to obtain a concentration in the sunflower seed slurry of from 0.15 to 1.50 wt. %, from 0.30 to 1.25 wt. %, or from 0.50 to 1.00 wt. %.

The washing of the sunflower oleosome concentrate in step c) of the process at of more than 7.2 and in the presence of reducing agent and/or acidulant may result in a sunflower oleosome concentrate with a creamy-white colour, having colour values according to CIELAB of:
°h in a range of from 85 to 95, from 86 to 94, or from 87 to 93 and C* of from 8.0 to 14.0, from 8.2 to 13.8, or from 8.4 to 13.6; or,
°h above 95, above 96, or above 97, and C* below 10.0, below 9.8, or below 9.6;
   measured on sunflower oleosome fraction standardized to a dry substance in a range of 30 to 35% and a pH in a range of 6.9 to 7.1, using an illuminant D65, an observation angle of 10°, specular component excluded and a view diameter of 30 mm.

### Further Treatment of the Sunflower Oleosome Fraction or the Sunflower Oleosome Concentrate

In one more aspect of the invention, the sunflower oleosome fraction or the sunflower oleosome concentrate, may be subjected to a heat treatment. The heat treatment may be a pasteurization treatment or an ultra-high-temperature (UHT) treatment. Pasteurization treatment involves heating the oleosomes at a temperature of 65° C. to 70° C. for 30 minutes in batch, or 80° C. to 86° C. for 15 to 30 seconds in a continuous-flow process (High temperature short time Pasteurization (HTST pasteurization)). UHT treatment involves heating of oleosomes at a temperature of 135° C. to 150° C. in a continuous-flow process and holding at that temperature for one or more seconds, up to 5 seconds, before cooling rapidly to room temperature.

Optionally, the sunflower oleosome fraction, the sunflower oleosome concentrate, the heat-treated sunflower oleosome fraction, or the heat-treated sunflower oleosome concentrate may be further subjected to a dehydration step by means of, but not limited to, spray drying or lyophilisation.

### The Sunflower Oleosome Fraction and Sunflower Oleosome Concentrate of the Present Invention

The invention also relates to a sunflower oleosome fraction or a sunflower oleosome concentrate comprising isolated and/or washed isolated oleosomes and a reducing agent and/or an acidulant in an amount of from 0.10 to 1.50 wt. %, from 0.20 to 1.25 wt. %, or from 0.50 to 1.00 wt. % based on total dry weight of sunflower oleosome fraction or concentrate, wherein the reducing agent and/or an acidulant is selected from the group consisting of ascorbic acid, erythorbic acid, allyl isothiocyanate, cysteine, glutathione, dithiothreitol, sodium bisulfite, citric acid, malic acid, carnosic acid, any derivative thereof and any combination of two or more thereof.

In one aspect of the invention, the sunflower oleosome fraction or the sunflower oleosome concentrate is characterized in that it has based on total dry matter:
a protein content of from 1.0 to 17.0 wt. %, from 1.5 to 16.0 wt. %, from 2.0 to 15.0 wt. %,
a lipid content of from 81.5 to 98.9 wt. %, from 83.5 to 98.4 wt. %, or from 84.5 to 97.9 wt. %, of which at least 60%, at least 70%, at least 80%, or at least 90% is present as oleosomes, and
a reducing agent and/or an acidulant in an amount of from 0.10 to 1.50 wt. %, from 0.20 to 1.25 wt. %, or from 0.50 to 1.00 wt. %,
wherein the reducing agent and/or an acidulant is selected from the group consisting of ascorbic acid, erythorbic acid, allyl isothiocyanate, cysteine, glutathione, dithiothreitol, sodium bisulfite, citric acid, malic acid, carnosic acid, any derivative thereof and any combination of two or more thereof.

The sunflower oleosome fraction or the sunflower oleosome concentrate may further comprise small amounts of remaining fibers in an amount of up to 0.5 wt. % and/or minerals, expressed as ash content in an amount of up to 0.7 wt. % on total dry matter.

In another aspect of the invention, the sunflower oleosome fraction or the sunflower oleosome concentrate is further characterized in that it has a creamy-white colour. The sunflower oleosome fraction or the sunflower oleosome concentrate has colour values according to CIELAB of
°h in a range of from 85 to 95, from 86 to 94, or from 87 to 93 and C* of from 8.0 to 14.0, from 8.2 to 13.8, or from 8.4 to 13.6; or.
°h above 95, above 96, or above 97, and C* below 10.0, below 9.8, or below 9.6;
   measured on sunflower oleosome fraction standardized to a dry substance in a range of 30 to 35% and a pH in a range of 6.9 to 7.1, using an illuminant D65, an observation angle of 10°, specular component excluded and a view diameter of 30 mm.

Furthermore, the sunflower oleosome fraction or the sunflower oleosome concentrate may be characterized by a mild, creamy sunflower taste and no bitterness or unpleasant taste.

### Process for Preparing Products Comprising the Sunflower Oleosome Fraction or the Sunflower Oleosome Concentrate

The invention also relates to a process for preparing food and feed products, pharmaceutical products, personal care products, nutritional compositions and industrial products, and the process is comprising the step of blending the sunflower oleosome fraction or the sunflower oleosome concentrate according to the invention with at least one ingredient other than oleosomes.

The at least one ingredient other than oleosomes may be, but is not limited to proteins, carbohydrates, fats, vitamins, minerals, trace elements, essential amino acids, essential fatty acids, and mixtures of two or more thereof. Preferably, the at least one ingredient is selected from the group consisting of proteins, carbohydrates, fats, essential amino acids, essential fatty acids, vitamins, and mixtures of two or more thereof.

Examples of such food and feed products include but are not limited to drinks such as coffee, black tea, powdered green tea, cocoa, juice etc.; milk component-containing drinks, such as raw milk, processed milk, lactic acid beverages, etc.; a variety of drinks including nutrition-enriched drinks, such as calcium-fortified drinks and the like and dietary fiber-containing drinks, etc.; chilled or ambient dairy products, such as butter, cheese, vegan cheese, yoghurt, coffee whitener, whipping cream, custard cream, custard pudding, etc.; processed fat food products, such as mayonnaise, margarine, spread, shortening, etc.; soups; stews; seasonings such as sauce, dressings, etc.; a variety of paste condiments represented by kneaded mustard; a variety of fillings typified by jam and flour paste; a variety or gel or paste-like food products including red bean-jam, jelly, and foods for swallowing impaired people; food products containing cereals as the main component, such as bread, noodles, pasta, pizza pie, corn flake, etc.; Japanese, US and European cakes, candy, cookie, biscuit, hot cake, chocolate, rice cake, etc.; kneaded marine products represented by a boiled fish cake, a fish cake, etc.; live-stock products represented by ham, sausage, hamburger steak, etc.; daily dishes such as cream croquette, paste for Chinese foods, gratin, dumpling, etc.; foods of delicate flavor, such as salted fish guts, a vegetable pickled in sake lee, etc.; liquid diets such as tube feeding liquid food, etc.; supplements; and pet foods.

Whereas traditional processes for preparing food and feed products will require an emulsification or homogenization step, the process of the current invention for preparing the food and feed products does not need such a homogenisation or emulsification step. A simple blending of the sunflower oleosome fraction or the sunflower oleosome concentrate with the other ingredients is sufficient.

Pharmaceutical products according to the invention may be formulated to include therapeutic agents, diagnostic agents and delivery agents. The pharmaceutical product will additionally contain an active ingredient as a therapeutic or diagnostic agent. The active ingredient can be anything that one wishes to deliver to a host. The active ingredient may be a protein or peptide that has therapeutic or diagnostic value. Such peptides include antigens (for vaccine formulations), antibodies, cytokines, blood clotting factors and growth hormones. An example of pharmaceutical product is a parenteral emulsion containing the sunflower oleosome fraction or the sunflower oleosome concentrate, and a drug.

Personal care products according to the invention include soaps, cosmetics, skin creams, facial creams, toothpaste, lipstick, perfumes, make-up, foundation, blusher, mascara, eyeshadow, sunscreen lotions, hair conditioner, and hair colouring.

Industrial products according to the invention include paints, coatings, lubricants, films, gels, drilling fluids, paper sizing, latex, building and road construction material, inks, dyes, waxes, polishes and agrochemical formulations.

Nutritional compositions according to the invention may be compositions that are developed to cover the nutritional needs, either as a supplement, or as a complete nutrition. The people that are targeted for the nutritional composition according to the invention relate to specific groups of people, such as, but not limited to, preterm infants, infants, toddlers, elderly people, athletes or humans having nutritional deficiencies and/or having a deficient immune system. They may be designed for people suffering a more specific disease state such as cancer, chronic obstructive pulmonary disease, and later-stage kidney disease and others. Amongst others, nutritional compositions may be helpful for people who struggle with a loss of appetite, have difficulty chewing, have trouble preparing balanced meals, and/or are recovering from surgery or an illness. In the event that the nutritional composition is meant for a complete nutrition, it can provide a healthy balance of protein, carbohydrate, and/or fat.

These nutritional compositions can be in the form of liquid, as a ready-to-drink formula or used in feeding tubes. It can also be in the form of a formula base i.e. a powder or a concentrated liquid, to be dissolved in water or in another fluid for the preparation of a ready-to-drink nutritional composition. The nutritional composition may also be in the form of a pudding or a jelly, or in form of a cookie or a snack bar, or in any other form.

In one aspect of the invention the nutritional composition is comprising the sunflower oleosome fraction or the sunflower oleosome concentrate in an amount of from 1 to 70 weight % on dry matter of the nutritional composition. The nutritional composition is comprising the sunflower oleosome fraction or the sunflower oleosome concentrate in an amount of from 5 to 65 weight %, from 10 to 60 weight %, from 15 to 55 weight %, from 20 to 50 weight %, or from 25 to 45 weight % on dry matter of the nutritional composition.

In another aspect of the invention the nutritional composition further comprises at least one non-nutritional ingredients.

Non-nutritional ingredients according to the invention are ingredients that do not substantially add to the caloric intake and/or do not substantially provide micronutrients. Examples of non-nutritional ingredients are flavors, colorants, emulsifiers, acid regulators such as citric acid or lactic acid, preservatives, and the like. The non-nutritional ingredients may be from a natural or synthetic origin.

In yet another aspect of the invention, the at least one ingredient other than oleosomes is not an emulsifier.

Use of a Reducing Agent and/or an Acidulant

The current invention further relates to the use of a reducing agent and/or an acidulant for preventing green coloring of a sunflower oleosome fraction or a sunflower oleosome concentrate, wherein the reducing agent and/or an acidulant is selected from the group consisting of ascorbic acid, erythorbic acid, allyl isothiocyanate, cysteine, glutathione, dithiothreitol, sodium bisulfite, citric acid, malic acid, carnosic acid, any derivative thereof, and any combination of two or more thereof.

In one aspect, it relates to the use, wherein the reducing agent and/or an acidulant is present while grinding of the sunflower seeds and/or is added to the obtained sunflower seed slurry

In one more aspect, it relates to the use wherein the reducing agent and/or an acidulant is present while washing the sunflower oleosome fraction.

In a preferred aspect, it relates to the use, wherein the reducing agent and/or an acidulant is selected from the group consisting of cysteine, ascorbic acid, erythorbic acid and any combination of two or more thereof; more preferably the antioxidant is ascorbic acid and/or cysteine.

In yet another aspect, it relates to the use, wherein reducing agent and/or an acidulant is present in an amount of from 0.15 to 1.50 wt. %, from 0.30 to 1.25 wt. %, or from 0.50 to 1.00 wt. %.

### EXAMPLES

### Step a): Preparation of the Sunflower Seed Slurry

200 g of dehulled seeds from high-oleic sunflower were soaked overnight in de-ionized water (ratio 1:2 seeds: water) at 4° C. The soaking water was discarded, and the soaked seeds were washed with de-ionized water at 4° C. (ratio 1:2 seed: water). The dry substance (DS %) of the washed seeds was adjusted to 18% with de-ionized water at 4° C. and subsequently milled in a Vorwerk Thermomix for 90 seconds at 10700 rpm. A sunflower seed slurry was obtained.

The sunflower slurry was divided into different samples to which reducing agents and/or acidulants were added according to table 1. No acidulant or reducing agent was added to the comparative samples. The pH of the different samples of sunflower seed slurry was adjusted with NaOH (1M) according to table 1. The samples were left under magnetic stirring for 1 hour.

### Step b): Isolation of Sunflower Oleosome Fractions

The sunflower seed slurry of each sample was filtered over a nylon filter with a pore diameter of 80 μm. The filtrate was collected and subsequently centrifuged for 1 h at 4700 rpm and 4° C. using a Thermo Scientific Legend XFR Centrifuge. The centrifugation process separated the liquid phase further into two liquid phases: a hydrophilic phase (supernatant) which was a watery solution of proteins, carbohydrates and soluble fibers and a hydrophobic phase (creamy top layer) which was the desired sunflower oleosome fraction. The desired sunflower oleosome fraction was collected.

### Step c) Washing the Sunflower Oleosome Fraction and Isolating a Sunflower Oleosome Concentrate

The sunflower oleosome fraction was subsequently washed in a buffer solution or salt solution as indicated in table 1. The pH of the different samples further adjusted using NaOH (1M) or HCl (1M) according to table 1. The samples were left under magnetic stirring for 1 hour. The samples were subsequently centrifuged for 1 h at 4700 rpm and 4° C. using a Thermo Scientific Legend XFR Centrifuge. After centrifugation, the creamy top layer was collected, i.e. the sunflower oleosome concentrate.

### Colour Measurement

For colour measurement, the oleosome fraction or oleosome concentrate of each sample was standardized to a pH in a range of 6.9 to 7.1 and a dry matter content of 35% prior to color measurement.

L*a*b* was measured in a Konica Minolta spectrophotometer CM-5 with the following measurement settings:
Measurement type: reflectance
View diameter: 30 mm
Specular component excluded (SCE)
Auto-measurement: 3 times
Observer angle: 10°
Illuminant: D65

TABLE 1

| | | | |
|---|---|---|---|
| Comparative | Comparative | | |
| example 1 | example 2 | Sample 1 | Sample 2 |

Step a) - Preparation of the sunflower seed slurry

| | | | | |
|---|---|---|---|---|
| Type acidulant/ | — | — | ascorbic acid | cysteine |
| reducing agent | | | | |
| Dosage acidulant/ | — | — | 1% | 0.1% |
| reducing agent | | | | |
| pH sunflower | 7.0 | 8.5 | 8.5 | 9.0 |
| seed slurry | | | | |

Step c) - Washing the sunflower oleosome fraction
and isolating a sunflower oleosome concentrate

| | | | | |
|---|---|---|---|---|
| Aqueous solution | 0.2M KCl | Demineralized | 0.03M NaHCO3 | /* |
| | | water | | |
| pH at washing | 7.0 | 6.8 | 6.8 | /* |

*For sample 2, only a sunflower oleosome fraction was obtained, no further washing step c) was conducted.

### Results

Table 2 shows the yield of the sunflower oleosome fractions obtained in comparative sample 1 and 2, and samples 1 and 2. The yield is expressed as the weight of the oleosome sunflower fraction on the weight of the sunflower seed slurry.

Furthermore, table 2 shows the colour measurement of the oleosome concentrate or fraction as well as the visual colour description.

TABLE 2

| | Comparative | Comparative | | |
|---|---|---|---|---|
| | example 1 | example 2 | Sample 1 | Sample 2 |
| Yield sunflower | 26% | 48% | 45% | 50% |
| oleosome fraction | | | | |
| Colour measurement | sunflower | sunflower | sunflower | sunflower |
| | oleosome | oleosome | oleosome | oleosome |
| | concentrate | concentrate | concentrate | fraction |
| L* | +81.74 | +78.02 | +83.05 | +82.92 |
| a* | +1.47 | −3.14 | +0.77 | +0.31 |
| b* | +11.21 | +6.59 | +8.64 | +10.75 |
| °h | 82.53° | 115.48° | 84.91° | 88.35° |
| C* | 11.31 | 7.30 | 8.67 | 10.75 |
| Visual colour | Creamy white | Dark green | White | Creamy white |
| description | | | | |

1. A process for isolating a sunflower oleosome fraction, and the process comprises the steps, in order, of:
a) Grinding sunflower seeds in the presence of an aqueous solution and obtaining a sunflower seed slurry having a pH of more than 7.2, wherein a reducing agent and/or an acidulant is added during the grinding and/or wherein a reducing agent and/or an acidulant is added to the obtained sunflower seed slurry; and
b) Isolating from the sunflower seed slurry a sunflower oleosome fraction,
wherein the reducing agent and/or an acidulant is selected from the group consisting of ascorbic acid, erythorbic acid, allyl isothiocyanate, cysteine, glutathione, dithiothreitol, sodium bisulfite, citric acid, malic acid, carnosic acid, any derivative thereof and any combination of two or more thereof.

2. The process according to claim 1, wherein the process is a further process step c) of washing the sunflower oleosome fraction obtained from step b) in an aqueous solution and isolating a sunflower oleosome concentrate.

3. The process according to claim 2, wherein the aqueous solution in step c) has a pH of more than 7.2 and is comprising a reducing agent and/or an acidulant.

4. The process according to claim 1, wherein the grinding of the sunflower seeds is preceded by soaking and/or washing of the sunflower seeds.

5. The process according to claim 1, wherein the sunflower oleosome fraction or sunflower oleosome concentrate is further subjected to a heat treatment step and/or a dehydration step.

6. The process according to claim 1, wherein the sunflower seeds are sourced from high oleic and/or mid oleic sunflower seeds.

7. The process according to claim 1, wherein the reducing agent and/or an acidulant is added in step a) in an amount of from 0.15 to 1.50 wt % based on total dry weight of the sunflower seed slurry.

8. A sunflower oleosome fraction or sunflower oleosome concentrate comprising isolated and/or washed isolated sunflower oleosomes and an amount of reducing agent and/or acidulant in a range of from 0.10 to 1.50 wt % on total dry weight of the sunflower oleosome fraction or concentrate, wherein the reducing agent and/or an acidulant is selected from the group consisting of ascorbic acid, erythorbic acid, allyl isothiocyanate, cysteine, glutathione, dithiothreitol, sodium bisulfite, citric acid, malic acid, carnosic acid, any derivative thereof and any combination of two or more thereof.

9. The sunflower oleosome fraction or sunflower oleosome concentrate according to claim 8, wherein the sunflower oleosome fraction has, bases on total dry matter:
a protein content of from 1.0 to 17.0 wt. %, from 1.5 to 16.0 wt. %, or from 2.0 to 15.0 wt. %,
a lipid content of from 81.5 to 98.9 wt. %, from 83.5 to 98.4 wt. %, or from 84.5 to 97.9 wt. %, of which at least 60%, at least 70%, at least 80%, or at least 90% is present as oleosomes, and
a reducing agent and/or an acidulant in an amount of from 0.10 to 1.50 wt. %, from 0.30 to 1.25 wt. %, or from 0.50 to 1.00 wt. %.

10. The sunflower oleosome fraction or sunflower oleosome concentrate according to claim 8, wherein the sunflower oleosome concentrate has colour values according to CIELAB of:
°h in a range of from 85 to 95, from 86 to 94, or from 87 to 93 and C* of from 8.0 to 14.0, from 8.2 to 13.8, or from 8.4 to 13.6; or
°h above 95, above 96, or above 97, and C* below 10.0, below 9.8, or below 9.6;
measured on sunflower oleosome fraction standardized to a dry substance in a range of 30 to 35% and a pH in a range of 6.9 to 7.1, using an illuminant D65, an observation angle of 10°, specular component excluded and a view diameter of 30 mm.

11. A process for preparing food and feed products, pharmaceutical products, personal care products, nutritional compositions and industrial products, and the process is comprising the step of blending the sunflower oleosome fraction or the sunflower oleosome concentrate according to claim 8, with at least one ingredient other than oleosomes.

12. (canceled)
